(19) United States
(12) Patent Application Publication
(10) Pub. No.: US 2025/0089750 A1
(43) Pub. Date: Mar. 20, 2025

(54) SWEETENED COMPOSITION

(71) Applicant: Firmenich SA, Satigny (CH)

(72) Inventors: Ronald SKIFF, Plainsboro, NJ (US); Pierre-Etienne BOUQUERAND, Satigny (CH); Maxime DELATTRE, Satigny (CH)

(21) Appl. No.: 18/291,519

(22) PCT Filed: Aug. 12, 2022
(86) PCT No.: PCT/EP22/72633

§ 371 Date: Jan. 23, 2024

Related U.S. Application Data
(60) Provisional application No. 63/233,999, filed on Aug. 17, 2021.

(30) Foreign Application Priority Data
Sep. 22, 2021 (EP) 21198215.2

(51) Int. Cl. A23L 27/12; A23F 3/40; A23L 27/30; A23P 20/10

(52) U.S. Cl. CPC A23L 27/13; A23F 3/405; A23L 27/30; A23P 20/11

(57) ABSTRACT

Described herein are a sweetened composition, a process for preparing the sweetened composition, and consumer products including the sweetened composition.

### TECHNICAL FIELD

The present invention relates to the field of delivery systems. More particularly, the invention pertains to a sweetened composition. A process for preparing the sweetened composition is also an object of the invention. Consumer products comprising said sweetened composition are also part of the invention.

### BACKGROUND OF THE INVENTION

The sweet taste of many foods and beverages plays an important role for these foods and beverages to be consumed and appreciated by customers.

In some cases, the natural sweetening capacity of ingredients being comprised in foods and beverages is not sufficient to meet the customers' preference. Therefore, said foods and beverages are often sweetened by the customers themselves, often with high amounts of high caloric sugars, which may lead to health problems in the long term.

In particular tea and coffee infusion beverages are often sweetened by customers with high caloric sweeteners such as conventional sugars. Therefore, it is desirable to modify e.g. naturally occurring tea leaves and coffee beans such that the sweetness perception of beverages prepared with said tea leaves and coffee beans, respectively, is enhanced. This may render it less likely that customers further sweeten the coffee or tea beverage on their own, which may reduce or prevent over sweetening of said beverages with high caloric sugars. In the long term, this may lead to less intake of high caloric sweeteners and thus to less health problems associated therewith. Further, already sweetened naturally occurring ingredients such as tea leaves or coffee beans, provide a certain convenience for the customer.

At the same time, it is also advantageous to provide naturally occurring food and beverage materials with a certain flavour and/or taste.

One of the problems faced by the flavour industry lies in the relatively rapid loss of olfactive benefit provided by active compounds due to their volatility, particularly that of “top-notes”. The encapsulation of those active substances provides at the same time a protection of the ingredients there-encapsulated against “aggressions” such as oxidation or moisture and allows, on the other hand, a certain control of the kinetics of flavour release to induce sensory effects through sequential release.

### SUMMARY OF THE INVENTION

In a first aspect, the present invention relates to a dry sweetened composition comprising:
an insoluble food carrier,
a coating on the insoluble carrier, wherein the coating comprises:
   a sweetener,
   a water-soluble matrix material, and
   optionally an emulsifier.

Another object of the invention relates to a process for preparing the dry sweetened composition according to the present invention, wherein the process comprises the steps of:
a) Preparing a mixture comprising:
   optionally, an oil comprising a flavor oil,
   a water-soluble matrix material,
   a sweetener, and
   optionally an emulsifier
b) Blending the mixture obtained in step a) with an insoluble food carrier to form the dry sweetened composition.

A third aspect of the invention relates to a consumer product comprising the dry sweetened composition according to the invention.

### DETAILED DESCRIPTION OF THE INVENTION

Unless stated otherwise, percentages (%) are meant to designate a percentage by weight.

By “room temperature” it is meant a temperature from 20° C. to 25° C.

By “water-soluble flavour or flavour oil”, it is meant a single flavouring compound or a mixture of several flavouring compounds.

“Emulsifiers” are amphiphilic molecules that concentrate at the interface between two phases and modify the properties of that interface. Examples of emulsifiers can be found in McCutcheon's

Emulsifiers & Detergents or the Industrial Surfactants Handbook.

By a “dry composition”, it should be understood a composition that has a water activity below 0.6, preferably below 0.5, more preferably below 0.4.

Under “coating”, a coating is understood that homogeneously (fully) coats the insoluble food carrier but also a coating that heterogeneously (partially) coats the insoluble food carrier.

In the present invention, the terms “flavour” and “flavor” are used indifferently.

The present invention relates in a first aspect to a dry sweetened composition comprising:
an insoluble food carrier,
a coating on the insoluble carrier, wherein the coating comprises:
   a sweetener,
   a water-soluble matrix material, and
   optionally an emulsifier.

According to the invention, the dry sweetened composition comprises an insoluble food carrier. Insoluble means in this regard that the food carrier is not soluble in water.

In a particular embodiment, the insoluble food carrier is selected from the group consisting of flowers, leaves, beans, seeds, algae, fruit pieces, vegetable pieces, powders, and particles.

Preferably, the insoluble food carrier is selected from the group consisting of tea leaves and coffee beans. More preferably, the insoluble food carrier is tea leaves. The leaves may be whole leaves, cut leaves, ground leaves, powdered leaves, in particular in form of free-flowing powders, or particles. The coffee beans may be unground or ground coffee beans.

In a particular embodiment, the insoluble food carrier is selected from the group consisting of an herbal carrier, a fruit carrier, and other botanicals.

In a particular embodiment, the insoluble food carrier may be algae, preferably seaweed.

In a particular embodiment, the insoluble food carrier is one or more fruit pieces. The one or more fruit pieces may stem from the same type of fruit or from different types of fruits. The one or more fruit pieces may stem from e.g. apples, pears, oranges, mandarins, limes, nectarines, apricots, peaches, plums, bananas, mangoes, strawberries, raspberries, blueberries, kiwifruit, passionfruit, and/or watermelons.

In a particular embodiment, the insoluble food carrier is one or more vegetable pieces. The one or more vegetable pieces may stem from the same type of vegetable or from different types of vegetables.

According to the invention, the coating on the insoluble carrier comprises a sweetener.

The term “sweetener” includes a single sweetener or a combination of sweeteners. Any suitable sweetener can be used.

In some embodiments, the sweetener is a common saccharide sweetener, such as sucrose, fructose, glucose, and sweetener compositions comprising natural sugars, such as corn syrup (including high fructose corn syrup) or other syrups or sweetener concentrates derived from natural fruit and vegetable sources.

In some other embodiments, the sweetener is selected from rare natural sugars including D-allose, D-psicose, L-ribose, D-tagatose, L-glucose, L-fucose, L-arbinose, D-turanose, and D-leucrose. In some embodiments, the sweetener is selected from semi-synthetic “sugar alcohol” sweeteners such as erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, isomaltulose, maltodextrin, and the like.

In some embodiments, the sweetener is selected from artificial sweeteners such as aspartame, saccharin, acesulfame-K, cyclamate, sucralose, and alitame. Other non-limiting examples of sweeteners include cyclamic acid, tagatose, maltose, galactose, mannose, sucrose, fructose, lactose, allulose, neotame and other aspartame derivatives, glucose, D-tryptophan, glycine, maltitol, lactitol, isomalt, hydrogenated glucose syrup (HGS), hydrogenated starch hydrolyzate (HSH), stevioside, rebaudioside A, other sweet Stevia-based glycosides, chemically modified steviol glycosides (such as glucosylated steviol glycosides), mogrosides, chemically modified mogrosides (such as glucosylated mogrosides), carrelame and other guanidine-based sweeteners.

In some embodiments, the sweetener is a combination of two or more of the sweeteners as mentioned herein. In some embodiments, the sweetener may be a combination of two, three, four or five sweeteners as disclosed herein. In some embodiments, the sweetener may be a sugar. In some embodiments, the sweetener may be a combination of one or more sugars and other natural and artificial sweeteners.

Further non-limiting examples of sweeteners include agave inulin, agave nectar, agave syrup, amazake, brazzein, brown rice syrup, coconut crystals, coconut sugars, coconut syrup, date sugar, fructans (also referred to as inulin fiber, fructo-oligosaccharides, or oligo-fructose), green stevia powder, Stevia rebaudiana, rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, rebaudioside M and other sweet stevia-based glycosides, stevioside, stevioside extracts, honey, Jerusalem artichoke syrup, licorice root, luo han guo (fruit, powder, or extracts), lucuma (fruit, powder, or extracts), maple sap (including, for example, sap extracted from Acer saccharum, Acer nigrum, Acer rubrum, Acer saccharinum, Acer platanoides, Acer negundo, Acer macrophyllum, Acer grandidentatum, Acer glabrum, Acer mono), maple syrup, maple sugar, walnut sap (including, for example, sap extracted from Juglans cinerea, Juglans nigra, Juglans ailatifolia, Juglans regia), birch sap (including, for example, sap extracted from Betula papyrifera, Betula alleghaniensis, Betula lenta, Betula nigra, Betula populifolia, Betula pendula), sycamore sap (such as, for example, sap extracted from Platanus occidentalis), ironwood sap (such as, for example, sap extracted from Ostrya virginiana), mascobado, molasses (such as, for example, blackstrap molasses), molasses sugar, monatin, monellin, cane sugar (also referred to as natural sugar, unrefined cane sugar, or sucrose), palm sugar, panocha, piloncillo, rapadura, raw sugar, rice syrup, sorghum, sorghum syrup, cassava syrup (also referred to as tapioca syrup), thaumatin, yacon root, malt syrup, barley malt syrup, barley malt powder, beet sugar, cane sugar, crystalline juice crystals, caramel, carbitol, carob syrup, castor sugar, hydrogenated starch hydrolates, hydrolyzed can juice, hydrolyzed starch, invert sugar, anethole, arabinogalactan, arrope, syrup, P-4000, acesulfame potassium (also referred to as acesulfame K or ace-K), alitame (also referred to as aclame), advantame, aspartame, baiyunoside, neotame, benzamide derivatives, bernadame, canderel, carrelame and other guanidine-based sweeteners, vegetable fiber, corn sugar, coupling sugars, curculin, cyclamates, cyclocarioside I, demerara, dextran, dextrin, diastatic malt, dulcin, sucrol, valzin, dulcoside A, dulcoside B, emulin, enoxolone, maltodextrin, saccharin, estragole, ethyl maltol, glucin, gluconic acid, glucono-lactone, glucosamine, glucoronic acid, glycerol, glycine, glycyphillin, glycyrrhizin, glycyrrhetic acid monoglucuronide, golden sugar, yellow sugar, golden syrup, granulated sugar, gynostemma, hernandulcin, isomerized liquid sugars, jallab, chicory root dietary fiber, kynurenine derivatives (including N′-formyl-kynurenine, N′-acetyl-kynurenine, 6-chloro-kynurenine), galactitol, litesse, ligicane, lycasin, lugduname, guanidine, falernum, mabinlin I, mabinlin II, maltol, maltisorb, maltodextrin, maltotriol, mannosamine, miraculin, mizuame, mogrosides (including, for example, mogroside IV, mogroside V, and neomogroside), mukurozioside, nano sugar, naringin dihydrochalcone, neohesperidine dihydrochalcone, nib sugar, nigero-oligosaccharide, norbu, orgeat syrup, osladin, pekmez, pentadin, periandrin I, perillaldehyde, perillartine, petphyllum, phenylalanine, phlomisoside I, phlorodizin, phyllodulcin, polyglycitol syrups, polypodoside A, pterocaryoside A, pterocaryoside B, rebiana, refiners syrup, rub syrup, rubusoside, selligueain A, shugr, siamenoside I, siraitia grosvenorii, soybean oligosaccharide, Splenda, SRI oxime V, steviol glycoside, steviolbioside, stevioside, strogins 1, 2, and 4, sucronic acid, sucrononate, sugar, suosan, phloridzin, superaspartame, tetrasaccharide, threitol, treacle, trilobtain, tryptophan and derivatives (6-trifluoromethyl-tryptophan, 6-chloro-D-tryptophan), vanilla sugar, volemitol, birch syrup, aspartame-acesulfame, assugrin, and combinations or blends of any two or more thereof.

The sweeteners may be present at any suitable concentration range, which can be adjusted by the skilled artisan according to the potency of the sweetener in question. For example, high-potency sweeteners, such as steviol glycosides, mogrosides, sucralose, aspartame, neotame, or acesulfame potassium, are typically used in lower concentrations. Caloric sweeteners, such as sucrose, fructose, and glucose, for example, are typically used at higher concentrations.

In some embodiments, the sweetener is a mogroside, such as monk fruit juice or extract, or one or more compounds extracted from monk fruit, such as mogroside III, mogroside IV, mogroside V, siamenoside I, isomogroside V, mogroside IVE, isomogroside IV, mogroside IIIE, 11-oxomogroside V, the 1,6-α isomer of siamenoside I, and the like. The term “monk fruit” refers to the fruit of the plant Siraitia grosvenorii, which is also called “luo han guo” or “LHG.” In some embodiments, the sweetener is monk fruit juice or monk fruit extract. The term “monk fruit juice” refers to a composition obtained by crushing the fruit and removing at least a portion of its fibrous material. The term “monk fruit extract” refers to the composition obtained from subjecting the monk fruit juice to any suitable process to increase the concentration of mogroside compounds, such as mogroside V, in the composition relative to their concentration in the juice. Such mogroside juices and extracts can be subjected to decolorization by any suitable means.

In a particular embodiment, the sweetener is monk fruit juice or extract. Preferably, the sweetener is monk fruit extract.

In some embodiments, the sweetener is a steviol glycoside, such as a stevia extract or one or more compounds extracted from stevia, such as rebaudioside A, rebaudioside B, rebaudioside M, rebaudioside D, or rebaudioside E. In some related embodiments, the sweetener includes glucosylated steviol glycosides. The term “glucosylated steviol glycoside” or “GSG” refers to the product of enzymatically glucosylating natural steviol glycoside compounds. The glucosylation generally occurs through a glycosidic bond, such as an α-1,2 bond, an α-1,4 bond, an α-1.6 bond, a β-1,2 bond, a β-1,4 bond, a β-1,6 bond, and so forth.

In a particular embodiment, the sweetener includes, preferably consists of, glucosylated steviol glycosides.

In some embodiments, the sweetener is a synthetic high potency sweetener. Non-limiting examples include acesulfame potassium (acesulfame K), aspartame, neotame, cyclamate, saccharin, and sucralose.

In a particular embodiment, the sweetener is selected from acesulfame K and aspartame. Preferably, the sweetener is a combination of acesulfame K and aspartame.

The aforementioned sweeteners can also be used in combination with certain sweetness-enhancing compounds, which are compounds that enhance the degree to which a human subject perceives a certain sweetener to be sweet at a particular concentration. Sweetness enhancers are typically used at low concentrations, such as concentrations ranging from 1 ppm to 50 ppm, based on the total weight of a beverage. When present, even at such low concentrations, one can reduce the concentration of sweetener by as much as half and obtain a comparable sweetness to a composition containing a normal concentration of the sweetener and no sweetness enhancer. Some non-limiting examples of sweetness enhancers include hesperetin dihydrochalcone, hesperetin dihydrochalcone-4′-O′glucoside, neohesperetin dihydrochalcone, brazzein, hesperidin, phyllodulcin, naringenin, naringin, phloretin, glucosylated steviol glycosides, (2R,3R)-3-acetoxy-5,7,4′-trihydroxyflavanone, (2R,3R)-3-acetoxy-5,7,3′-trihydroxy-4′-methoxyflavanone, rubusosides, thaumatin, monellin, miraculin, glycyrrhizin and comestible acceptable salts thereof (such as the mono-ammonium salt), naringin dihydrochalcone, myricetin, nobiletin, polymethoxyflavones, mixed methoxy- and hydroxyflavones, quercetin, certain amino acids, and the like. Such compounds may also function to block the perceived bitterness of bitter tastants, such as bitter tastants naturally found in tea (e.g., tannins).

In a particular embodiment, the sweetener is selected from the group consisting of sucrose, glucose, fructose, stevia extracts, glycosylated derivatives of stevia extracts, sugars, sucralose, D-tryptophan, NHDC, polyols, stevioside, Rebaudioside A, thaumatin, mogrosides, monellin, neotame, aspartame, alitame, potassium acesulfame, saccharine, monoammonium glycyrrhizinate, calcium cyclamate, sodium cyclamate, sodium saccharin, potassium saccharin, ammonium saccharin, calcium saccharin, and any mixtures thereof.

According to the invention, the coating comprises a water-soluble matrix material. According to the invention, the water-soluble matrix material and the sweetener are not one and the same compound/material.

The matrix material used in the present invention is water soluble. A “water-soluble matrix material” is intended for the purpose of the present invention as encompassing any matrix material, which forms a one-phase solution in water. Preferably, it forms a one phase solution when dissolved in water at concentrations as high as 20% by weight, more preferably even as high as 50% by weight. Most preferably it forms a one phase solution when dissolved in water at any concentration.

In a particular embodiment, the matrix material is selected from the group consisting of maltodextrin, modified starch, inulin, plant-based proteins, gums, soluble fibers, soluble polysaccharides, and any mixtures thereof.

According to a particular embodiment, the water-soluble matrix material is gum arabic.

According to a particular embodiment, the water-soluble matrix material is maltodextrin, preferably maltodextrin showing a DE-value of from 15 to 20, more preferably showing a DE-value of 18.

According to a particular embodiment, the water-soluble matrix material is modified starch.

The term “soluble fiber” as used herein refers to polysaccharides characterized as being soluble by using the official method of the Association of Official Analytical Chemists (Prosky et al, 1988; J. Assoc. Off Anal. Chem, 70, 5, 1017), e.g. water-soluble fibers, e.g. water soluble at room temperature. Said soluble fiber may be for example fruit fiber, grain fibers, natural soluble fibers and synthetic soluble fibers. Natural fibers include Soluble Corn Fiber, acacia and hydrolyzed guar gum. Synthetic soluble fibers include polydextrose, modified food starch, and similar. Food grade sources of soluble fiber useful in embodiments of the present invention include inulin, corn fiber, barley, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea) Danish potatoes, konjac vegetable fiber, psylliumfiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

According to a particular embodiment, the matrix material has emulsifying properties such as gum arabic. In this particular embodiment, the emulsifier is optional.

In a particular embodiment, the coating further comprises an emulsifier. The emulsifier may be selected from the group consisting of lecithin, glycerol esters, fatty acid esters, saponins, proteins, gum arabic, octenyl succinated starch, and mixtures thereof.

According to a particular embodiment, the emulsifier and the water-soluble matrix material are different materials.

In a particular embodiment, the coating further comprises an oil comprising a flavor oil.

Under an “oil”, a single type of oil or a mixture of several different types of oils is understood. In said embodiment, the oil comprises a flavor oil.

In a particular embodiment, the coating further comprises an aqueous natural extract comprising a water-soluble flavor.

By “water-soluble flavor or flavour oil” it is meant here a flavouring ingredient or a mixture of flavouring ingredients, solvent or adjuvants of current use for the preparation of a flavouring formulation, i.e. a particular mixture of ingredients which is intended to be added to an edible composition or chewable product to impart, improve or modify its organoleptic properties, in particular its flavour and/or taste. Taste modulator is also encompassed in said definition.

Flavouring ingredients are well known to a skilled person in the art and their nature does not warrant a detailed description here, which in any case would not be exhaustive, the skilled flavourist being able to select them on the basis of his general knowledge and according to the intended use or application and the organoleptic effect it is desired to achieve. Many of these flavouring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Solvents and adjuvants or current use for the preparation of a flavouring formulation are also well known in the art.

In a particular embodiment, the flavour oil is selected from the group consisting of terpenic flavours including citrus and mint oil, and sulfury flavours.

In a particular embodiment, the flavor oil is characterized by a log P value of 2 or more.

In a particular embodiment, the flavor oil is bergamot flavor oil.

In a particular embodiment, the flavor oil is lemon flavor oil.

In a particular embodiment, the flavor oil is molasses flavor oil.

According to a particular embodiment, the water-soluble flavor has a Log P value less than 2.

In a particular embodiment, the coating comprises both an oil comprising a flavor oil and an aqueous natural extract comprising a water-soluble flavor. In said embodiment, the weight ratio between the water-soluble flavor and the flavor oil is preferably above 0.05, more preferably above 0.06.

The flavor oil mentioned above is hydrophobic (i.e non-water soluble). In other words, the flavor oil forms two phases when dispersed in water contrary to the water-soluble flavour, which forms a single phase when dispersed in water.

The natural extract mentioned above can be selected from the group consisting of fruit juices, fruit syrup, fruit extract, coffee extract, honey extract, extracts of flowers, leaves and mixtures thereof. According to an embodiment, the natural extract comprises up to 10% by weight of a water-soluble flavor.

In a particular embodiment, the coating may comprise both the flavor oil and the water-soluble flavor in the form of a free flavor. By “free flavor” a flavor is meant that is not encapsulated.

According to another embodiment, both the flavor oil and the water-soluble flavor may be in an encapsulated form. According to another embodiment, both the flavor oil and the water-soluble flavor may be present as a mixture of free flavor and encapsulated flavor, the latter preferably consisting of water-insoluble microcapsules. Microcapsules can be obtained by any process known in the art and do not necessitate a more detailed description. As non-limiting examples, those water-insoluble microcapsules can be obtained by a process selected from the group consisting of interfacial polymerisation, polycondensation, simple and complex coacervation or a combination thereof. According to a particular embodiment the microcapsules have a core-shell structure with a polymeric shell. The nature of the polymeric shell from the microcapsules of the invention can vary. According to another embodiment, the microcapsules have a polymeric shell resulting from complex coacervation wherein the shell is possibly cross-linked such as described in WO2014044840 or WO2013174921.

According to an embodiment, the coating comprises:
between 0% and 25%, preferably between 7% and 23% of the oil comprising a flavor oil based on the total weight of the coating, and/or
between 1% and 50%, preferably between 10% and 30% of the sweetener based on the total weight of the coating, and/or
between 20% and 80%, preferably between 30% and 75% of the matrix material based on the total weight of the coating, and/or
between 0 and 5%, preferably between 1% and 3% of the emulsifier based on the total weight of the coating.

In a particular embodiment, the coating comprises between 0% and 25%, preferably between 7% and 23% of the oil comprising a flavor oil based on the total weight of the coating.

In a particular embodiment, the coating comprises between 1% and 50%, preferably between 10% and 30% of the sweetener based on the total weight of the coating.

In a particular embodiment, the coating comprises between 20% and 80%, preferably between 30% and 75% of the matrix material based on the total weight of the coating.

In a particular embodiment, the coating comprises between 0 and 5%, preferably between 1% and 3% of the emulsifier based on the total weight of the coating.

According to a particular embodiment, the coating represents between 0.8 and 20% by weight, preferably between 1.5 and 10%, based on the total weight of the sweetened composition.

In a particular embodiment, the insoluble food carrier amounts to more than 20% by weight, based on the total weight of the sweetened composition.

In a particular embodiment, the dry sweetened composition consists of the insoluble food carrier and the coating.

Another object of the invention is a process for preparing the dry sweetened composition according to the invention, wherein the process comprises the steps of:
a) Preparing a mixture comprising:
   optionally, an oil comprising a flavor oil,
   a water-soluble matrix material,
   a sweetener, and
   optionally an emulsifier
b) Blending the mixture obtained in step a) with an insoluble food carrier to form the dry sweetened composition.

In case the mixture comprises an oil comprising a flavor oil, the mixture is an emulsion showing an oil phase and a polar phase comprising the water-soluble ingredients. Depending on the nature of the sweetener, the sweetener will be present in the oil or polar phase.

Blending step b) can be done either at room temperature and/or low pressure, or at higher temperatures and/or low pressure.

During blending step b), to form the coating on the insoluble carrier, the mixture can be poured, sprinkled, sprayed, through a nozzle on the insoluble food carrier.

According to a particular embodiment, the mixture is blended with the insoluble food carrier at a temperature of less than 70° C. during step b), preferably at room temperature, to form the dry sweetened composition.

According to a particular embodiment, the process described above does not comprise any drying step that involves water removal. As drying steps involving water removal, one may cite for example, a spray-drying step or fluidizing bed step.

According to another embodiment, blending step b) is performed under vacuum at a temperature of from 25° C. to 70° C.

As the process according to some embodiments does not involve high temperatures, it provides the advantage of reducing possible volatile losses and respecting the initial flavour profile, in particular when the coating comprises a flavour oil and/or a water-soluble flavour. It is also a way of reducing the production costs and carbon footprint, and it avoids explosion risks associated with drying liquids in hot air.

In case oil comprising flavor oil is present in the mixture obtained in step a), the flavour oil may be in the form of a free oil dispersed in the polar phase. What is meant by “free oil” in the context of the invention is an oil that is not encapsulated. According to another embodiment, the flavour oil is in an encapsulated form dispersed in the polar phase, i.e. in the form of a slurry. According to a yet another embodiment, the flavour oil is present as a mixture of free oil and encapsulated oil. When the mixture prepared in the first step of the invention (step a) comprises flavor oil in an encapsulated form, the latter preferably consists of water-insoluble microcapsules. Those microcapsules can be obtained by any process known in the art and do not necessitate a more detailed description. As non-limiting examples, those water-insoluble microcapsules can be obtained by a process selected from the group consisting of interfacial polymerisation, polycondensation, simple and complex coacervation or a combination thereof. According to a particular embodiment the microcapsules have a core-shell structure with a polymeric shell. The nature of the polymeric shell from the microcapsules of the invention can vary. According to another embodiment, the microcapsules have a polymeric shell resulting from complex coacervation wherein the shell is possibly cross-linked such as described in WO2014044840 or WO2013174921.

According to a particular embodiment, the insoluble food carrier has a water activity below 0.6 preferably below 0.5, preferably below 0.4.

According to a particular embodiment, at the end of step b), the sweetened composition has a water activity below 0.6 preferably below 0.5, preferably below 0.4.

Water activity is a well-known parameter of expressing how much free water exists in a water-containing composition.

Water activity (aw) is the partial vapor pressure of water in a substance divided by the standard state partial vapor pressure of water. In the field of food science, the standard state is defined as the partial vapor pressure of pure water at the same temperature. Aw is an intrinsic property of a composition and can be easily determined by a skilled person using different methods such as resistive electrolytic, a capacitance or a dew point hygrometer.

For example, the water activity can be determined at 25° with a Rotronic Hygrolab cell with four decimal digit and calibrated with saturated salt solutions, USING SUPPLIER Quick Aw® function estimating Aw after 5 to 6 min equilibration.

According to a particular embodiment, the food carrier has a water activity below the critical water activity of water-soluble matrix material, wherein the sweetened composition after equilibration has still a water activity below the critical water activity of water-soluble matrix and the glass transition temperature of the sweetened composition is equal or higher than 25° C.

Critical water activity of water-soluble matrix (for example polysaccharides) a_{w}* has been defined by several authors as the a_{w} at which sufficient moisture is present to yield a glass transition value of 25° C. This practical metric of the hygroscopic stability of carbohydrate glasses can be measured or even predicted (M. Sillick, C. M. Gregson/Carbohydrate Polymers 79 (2010) 1028-1033).

According to a particular embodiment, the mixture obtained in step a) has a viscosity greater than 500 mPas, preferably greater than 900 mPas, wherein the viscosity is measured at 25° C. and at a shear rate of 100 s⁻¹. The viscosity can be measured, for example, with a TA Instruments AR2000 rheometer (New Castle, DE, USA) with concentric cylinder geometry.

Another object of the present invention is a consumer product comprising the sweetened composition according to the invention.

In a particular embodiment, the consumer product is a food product or a beverage.

Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

The dry sweetened composition according to the invention may be suitable for conveying sweetness and potentially flavoring to beverages, fluid dairy products, condiments, baked goods, frostings, bakery fillings, candy, chewing gum and other food products.

Beverages include, without limitation, powdered drinks, as well as liquid concentrates such as fountain syrups and cordials; hot beverages including malt drinks, cocoa, coffee and coffee-based drinks, coffee substitutes and cereal-based beverages; instant beverages such as instant coffee, teas, including dry mix products as well as ready-to-drink teas (herbal and tealeaf based); fruit and vegetable juices and juice flavored beverages as well as juice drinks, nectars, concentrates, the dry flavored mouth care products or pharmaceutical products.

As non-limiting examples, the consumer product is in the form of a
Baked goods (e.g. bread, dry biscuits, cakes, other baked goods),
Instant beverages (e.g. hot drinks, instant vegetable drinks, powdered soft drinks, instant coffee and tea, chocolate drinks, malt drinks),
Cereal products (e.g. breakfast cereals, pre-cooked ready-made rice products, rice flour products, millet and sorghum products, raw or pre-cooked noodles and pasta products),
condensed milk and analogues,
Confectionary products (e.g. chewing gum, hard and soft candy)
Chocolate and compound coatings
Dried egg
Vegetarian meat replacer, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts).

According to a particular embodiment, the consumer product comprising the sweetened composition is in the form of hot or cold beverages, or herbal infusions.

In a particular embodiment, the consumer product comprises the sweetened composition according to the present invention in an amount of from 0.8% to 100%, preferably of from 1% to 50%, more preferably of from 1.5% to 20%, based on the total weight of the consumer product.

A further object of the present invention is a method of preparing the consumer product, preferably a food product or a beverage, wherein the method comprises the following steps:
a. providing a consumer product, preferably a food product or beverage,
b. adding the sweetened composition of the present invention to the consumer product.

The consumer product, preferably a food product or beverage, may already be sweetened and potentially flavored before adding the sweetened composition of the present invention, or may not yet be sweetened.

The sweetened composition may be added to the consumer product by any means of addition known by a person skilled in the art such as for example, but not limited to, conveying, mixing, coating, infusion or the like.

The invention will now be further described by way of examples. It will be appreciated that the invention as claimed is not intended to be limited in any way by these examples.

### Example 1

### Preparation of a Sweetened Composition According to the Invention

Glucosylated steviol glycosides (GSG), maltodextrin (DE-value of 18), and demineralized water were mixed at the quantities given in Table 1 below. First, GSG has been added to the demineralized water and mixed for 10 minutes at 400 rpm. Then, the slurry was allowed to stand at room temperature for 1 hour for the formed foam to diminish. Finally, the maltodextrin has been added and the resulting mixture has been mixed for 10 minutes at 800 rpm.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 1

| Ingredient | Quantity |
|---|---|
| Glucosylated steviol glycosides (GSG) | 400 g |
| Maltodextrin (DE-value of 18, Roquette Fréres) | 200 g |
| Demineralized water | 400 g |
| Total | 1000 g |

### Example 2

### Preparation of a Sweetened Composition According to the Invention

Monk fruit extract, gum arabic, and demineralized water were mixed at the quantities given in Table 2 below. First, gum arabic has been added to the demineralized water, wherein a third of the total quantity of gum arabic has been added to the water every 10 min and mixing has been applied at 400 rpm. The same procedure then has been repeated with the Monk fruit extract. The final mixture has been mixed again for 10 min at 800 rpm.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 2

| Ingredient | Quantity |
|---|---|
| Monk fruit extract | 100 g |
| Gum arabic (Nexira) | 400 g |
| Demineralized water | 500 g |
| Total | 1000 g |

Both non-coated tea leaves and coated tea leaves have further been used for the preparation of a tea beverage (hot water infusion of the non-coated and coated tea leaves, respectively). Further, a sensorial evaluation of the prepared tea beverages has been conducted as to the sweetness of the prepared tea beverages. It has been found that the tea beverage that has been prepared with the coated tea leaves showed a significantly higher sweetness compared to the tea beverage that has been prepared with the non-coated tea leaves (at a confidence level of 99.9% from a Duncan comparison test). Moreover, also a significantly longer sweetness impression has been found for the tea beverage that has been prepared with the coated tea leaves (at a confidence level of 99.9% from a Duncan comparison test).

### Example 3

### Preparation of a Sweetened Composition According to the Invention

Acesulfam K, Aspartame, Bergamot flavor oil, modified starch, and demineralized water were mixed at the quantities given in Table 3 below. First, Aspartame has been mixed with water for 5 minutes at 400 rpm. Then, Acesulfam K has been added while mixing for 5 minutes. Afterwards, the modified starch has been added and mixing has been applied for 10 minutes. Finally, the Bergamot flavor oil has been added and the final mixture has been mixed for 10 minutes.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 3

| Ingredient | Quantity |
|---|---|
| Acesulfam K | 100 g |
| Aspartam | 100 g |
| Bergamot flavor oil | 300 g |
| Modified starch (HI-CAP 100 IP, Ingredion) | 200 g |
| Demineralized water | 300 g |
| Total | 1000 g |

### Example 4

### Preparation of a Sweetened Composition According to the Invention

Molasses flavor, glucosylated steviol glycosides (GSG), maltodextrin (DE-value of 18), and demineralized water were mixed at the quantities given in Table 4 below. First, GSG has been dissolved in water, followed by the slow addition of maltodextrin. Then the molasses flavor has been added.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 4

| Ingredient | Quantity |
|---|---|
| Molasses flavor | 30 g |
| Glucosylated steviol glycosides (GSG) | 360 g |
| Maltodextrin (DE-value of 18, Roquette Fréres) | 210 g |
| Demineralized water | 400 g |
| Total | 1000 g |

Both non-coated tea leaves and coated tea leaves have further been used for the preparation of a tea beverage (hot water infusion of the non-coated and coated tea leaves, respectively). Further, a sensorial evaluation of the prepared tea beverages has been conducted as to the sweetness of the prepared tea beverages. It has been found that the tea beverage that has been prepared with the coated tea leaves showed a significantly higher sweetness compared to the tea beverage that has been prepared with the non-coated tea leaves (at a confidence level of 99.9% from a Duncan comparison test). Moreover, also a significantly longer sweetness impression has been found for the tea beverage that has been prepared with the coated tea leaves (at a confidence level of 99.9% from a Duncan comparison test).

It has further been found that tea beverage that has been prepared with the coated tea leaves showed a significantly decreased astringency compared to the tea beverage that has been prepared with the non-coated tea leaves (at a confidence level of 90% from a Duncan comparison test).

### Example 5

### Preparation of a Sweetened Composition According to the Invention

Sucralose, forest fruit flavor, gum arabic, and demineralized water were mixed at the quantities given in Table 5 below. First, sucralose has been dissolved in water, followed by the slow addition of gum arabic. Then the forest fruit flavor has been added.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 5

| Ingredient | Quantity |
|---|---|
| Sucralose | 100 g |
| Forest fruit flavor | 200 g |
| Gum arabic (Nexira) | 300 g |
| Demineralized water | 400 g |
| Total | 1000 g |

### Example 6

### Preparation of a Sweetened Composition According to the Invention

Lemon flavor, monk fruit, gum arabic, and demineralized water were mixed at the quantities given in Table 6 below. First, monk fruit has been dissolved in water, followed by the slow addition of gum arabic. Then the lemon flavor has been added.

The final mixture obtained thereby has been sprayed on tea leaves at a concentration of between 1 to 20 wt. % based on the total weight of the final sweetened composition.

Likewise, the final mixture obtained thereby has been sprayed on coffee beans at a concentration of between 1 to 20 wt. % based on the total weight of the final sweetened composition.

TABLE 6

| Ingredient | Quantity |
|---|---|
| Lemon flavor | 200 g |
| Monk fruit | 200 g |
| Gum arabic (Nexira) | 200 g |
| Demineralized water | 400 g |
| Total | 1000 g |

1. A dry sweetened composition comprising:
an insoluble food carrier, and
a coating on the insoluble carrier, wherein the coating comprises:
a sweetener,
a water-soluble matrix material, and
optionally an emulsifier.

2. The composition according to claim 1, wherein the coating comprises an oil comprising a flavor oil and/or an aqueous natural extract comprising a water-soluble flavor.

3. The composition according to claim 1, wherein the coating represents between 0.8 and 20% by weight based on the total weight of the sweetened composition.

4. The composition according to claim 1, wherein the coating comprises:
between 0% and 25% of the oil comprising a flavor oil based on the total weight of the coating, and/or
between 1% and 50% of the sweetener based on the total weight of the coating, and/or
between 20% and 80% of the matrix material based on the total weight of the coating, and/or
between 0 and 5% of the emulsifier based on the total weight of the coating.

5. The composition according to claim 1, wherein the sweetener is a natural sweetener or an artificial sweetener.

6. The composition according to claim 1, wherein the sweetener is selected from the group consisting of sucrose, glucose, fructose, stevia extracts, glycosylated derivatives of stevia extracts, sugars, sucralose, D-tryptophan, NHDC, polyols, stevioside, Rebaudioside A, thaumatin, mogrosides, monellin, neotame, aspartame, alitame, potassium acesulfame, saccharine, monoammonium glycyrrhizinate, calcium cyclamate, sodium cyclamate, sodium saccharin, potassium saccharin, ammonium saccharin, calcium saccharin, and any mixtures thereof.

7. The composition according to claim 1, wherein the matrix material is selected from the group consisting of maltodextrin, modified starch, inulin, plant-based proteins, gums, soluble fibers, soluble polysaccharides, and any mixtures thereof.

8. The composition according to claim 1, wherein the emulsifier is selected from the group consisting of lecithin, glycerol esters, fatty acid esters, saponins, proteins, gum Arabic, octenyl succinated starch, and mixtures thereof.

9. The composition according to claim 1, wherein the insoluble food carrier is selected from the group consisting of flowers, leaves, beans, seeds, algae, fruit pieces, vegetable pieces, powders, and particles.

10. A process for preparing the dry sweetened composition according to claim 1, wherein the process comprises the steps of:
a) preparing a mixture comprising:
optionally, an oil comprising a flavor oil,
a water-soluble matrix material,
a sweetener, and
optionally an emulsifier, and
b) blending the mixture obtained in step a) with an insoluble food carrier to form the dry sweetened composition.

11. The process according to claim 10, wherein during step b) the mixture is blended with the insoluble food carrier at a temperature of less than 70° C. to form the dry sweetened composition.

12. The process according to claim 10, wherein the mixture obtained in step a) has a viscosity greater than 500 mPas, wherein the viscosity is measured at 25° C. at a shear rate of 100 s⁻¹.

13. The process according to claim 10, wherein the insoluble food carrier has a water activity below 0.6.

14. A consumer product comprising the sweetened composition according to claim 1.

15. The consumer product according to claim 14, wherein the consumer product is a food product or a beverage.

16. The composition according to claim 1, wherein the coating comprises:
between 7% and 23% of the oil comprising a flavor oil based on the total weight of the coating, and/or
between 10% and 30% of the sweetener based on the total weight of the coating, and/or
between 30% and 75% of the matrix material based on the total weight of the coating, and/or
between 1 and 3% of the emulsifier based on the total weight of the coating.

17. The composition according to claim 1, wherein the insoluble food carrier is selected from the group consisting of tea leaves and coffee beans.

18. The process according to claim 10, wherein during step b) the mixture is blended with the insoluble food carrier at room temperature to form the dry sweetened composition.

19. The process according to claim 10, wherein the mixture obtained in step a) has a viscosity greater than 900 mPas, wherein the viscosity is measured at 25° C. at a shear rate of 100 s⁻¹.

20. The process according to claim 10, wherein the insoluble food carrier has a water activity below 0.5.
